(19) United States
(12) Patent Application Publication
(10) Pub. No.: US 2024/0075843 A1
(43) Pub. Date: Mar. 7, 2024

(54) ELECTRIC VEHICLE CHARGER SUITABLE FOR SINGLE PHASE, INCONSISTENT POWER SOURCES

(71) Applicant: One Three Energy, Inc., Cincinnati, OH (US)

(72) Inventors: Gregory York, Cincinnati, OH (US); Dale Friesen, Winnipeg (CA)

(21) Appl. No.: 18/179,787

(22) Filed: Mar. 7, 2023

Related U.S. Application Data
(60) Provisional application No. 63/481,324, filed on Jan. 24, 2023.
(60) Provisional application No. 63/481,332, filed on Jan. 24, 2023.
(60) Provisional application No. 63/481,342, filed on Jan. 24, 2023.
(60) Provisional application No. 63/362,551, filed on Apr. 6, 2022.

(51) Int. Cl. B60L 53/63

(52) U.S. Cl. CPC B60L 53/63

(57) ABSTRACT

Electrical power is supplied to an electric vehicle rapid DC charging station requiring a multi-phase electrical input, by converting single phase utility power using high-capacity converters of various designs. In certain embodiments, a low-capacity converter may also be coupled to single-phase utility power input for provision of power to the charging station when no vehicle is present for charging. In these embodiments, a transfer switch selectively couples the high-capacity converter or low-capacity converter to the rapid charging station as needed to charge an electric vehicle. Other embodiments may also include energy storage devices for enhancing charge rates or providing charging during periods of inadequate power availability or poor utility power quality.

### RELATED APPLICATIONS

This application claims priority to, and the benefit of the filing date of, U.S. Provisional Patent Application No. 63/362,551 filed on Apr. 6, 2022, as well as U.S. Provisional Patent Application No. 63/481,324 filed on Jan. 24, 2023, U.S. Provisional Patent Application No. 63/481,332 filed on Jan. 24, 2023, and U.S. Provisional Patent Application No. 63/481,342 filed on Jan. 24, 2023, the disclosures of which are incorporated by reference herein in their entireties.

### TECHNICAL FIELD

The present invention pertains to the wide-spread deployment of rapid charging systems for electric vehicles and specifically to innovations directed towards allowing those charging systems to operate in environments with single-phase AC utility supply and/or inconsistent electric power delivery.

### BACKGROUND

Chargers for plug-in electric vehicles (EVs) convert AC input voltage to an appropriate DC charging voltage, which is applied to the on-board energy storage system, typically an electric vehicle battery. The AC input voltage required by the charging system is typically provided by the local utility distribution power grid, and may be provided in a single-phase, split-phase (also called single-phase) or three-phase configurations.

EVs are known for efficient use of energy and zero emission characteristics (or more accurately “zero tail pipe emissions”—since the electric energy provided to an EV may create emissions if generated from a non-renewable resource). Consequently, there is substantial societal pressure to expand the use of electric vehicles and provide for their practical use outside of higher-density urban commuting areas where rapid DC charging systems are more easily deployed due to the ready availability of three-phase utility service.

A primary hurdle to the widespread adoption of EVs relates to “range anxiety”, namely the fear that an EV cannot be used for long-distance travel due to insufficient on-board energy storage (or range). While statistics show that 90-95% of all vehicle travel is well within the range of a typical commercially available EV, most consumers demand a vehicle that has the capability to travel longer distances effectively, even if such travel is rare. A secondary hurdle relates to availability of rapid charging facilities while traveling longer distances, where users may conveniently replenish the charge in their EV battery without incurring an extended charging session. This secondary concern is particularly relevant to travel in rural, or more remote settings, where access to rapid charging is compromised by constraints related to existing single-phase electric power infrastructure and its limited-service capacity.

Government funding programs are being launched to support the buildout of remote charging facilities across the country, which will allow for rapid charging of EVs when used for long distance travel. In many cases, these programs focus specifically on Level 3, rapid DC charging stations supporting 50-150 kW charge rates along Interstate routes, and ultimately, in other rural locations seeking to support electric vehicle travel. Level 3 rapid charging is important for reducing charging times to an acceptable duration of 30 minutes or less, which is broadly comparable to the time consumed for a conventional hydrocarbon refueling stop.

The societal effort to accelerate adoption of electric vehicles is often limited by the technical capabilities of the national power grid. As one example, the current capacity and structure of the distribution power grid is generally deemed to provide insufficient capacity for the delivery of energy required for charging of a national EV fleet equivalent to the current fleet of hydrocarbon-fueled vehicles. News reporting on this issue has focused upon the limited capacity of the existing and aging national electric utility infrastructure, which must be substantially improved and expanded to provide sufficient electrical capacity for delivery of required energy volumes needed for charging an ever-growing fleet of electric vehicles. However, there is a second issue that is less appreciated: Due to its higher charge rate and related electrical capacity requirements, DC fast charging requires a consistent multi-phase energy flow from the utility that is not readily available in many locations within existing infrastructure, particularly in rural or more remote locations served by commonly used single-phase infrastructure.

Furthermore, rural or more remote locations are frequently plagued by poor power quality with more frequent voltage fluctuations, surges/sags, interruptions, and lesser reliability than is common in higher-density urban settings with more robust utility networks. Long radial single-phase distribution feeders used in most rural networks are designed to serve widely-dispersed electric loads that are generally smaller in size, and therefore, often lack the electrical capacity and multi-phase configurations needed to support larger DC rapid charge stations.

Recently it has been proposed to include energy storage at DC rapid charge stations to address the lack of capacity in the utility distribution system. (i.e., inability to meet the coincidental peak power demand created by rapid DC charging stations). For example, batteries are charged by drawing lower levels of power over longer periods when the station is idle and not utilized for EV charging. The stored energy is then used to augment (or boost) the available capacity from the utility network when a charging session is activated. This approach is feasible given the lower usage factors applicable to rapid DC charging stations, particularly during nighttime and mid-day periods.

A further issue arises from the nature of single-phase distribution network used to serve many rural, or remote, locations across the United States, and other countries like Canada, Australia, etc. Specifically, many rural areas are supplied with long radial single-phase feeders rather the shorter higher capacity three-phase feeders used in higher-density urban locales where rapid DC charging stations are also located to support higher concentrations of local EV commuters. The primary advantage of single-phase power delivery relates to the cost of the utility distribution infrastructure, where for a given electrical capacity, a lower cost single or two-wire single phase distribution system requires fewer conductors and smaller structures, thus saving both conductor material and reducing required pole sizes relative to multi-phase systems.

In typical residential, agricultural, small commercial/industrial applications, higher voltage single-phase distribution power is delivered to each neighborhood (or service area) and then transformed to lower capacity 240V service for individual customers using pole-mounted single-phase center-tapped “split phase” transformers. The center tap is connected to a distribution system neutral or grounded with a short strap to the transformer case, forming a neutral terminal through the bonded ground conductor. This neutral terminal, along with the two secondary (or hot) terminals are delivered to each residence, thus providing two 120 VAC supplies with respect to the neutral, which are 180 degrees out of phase with each other and therefore capable of providing a 240 VAC supply for larger equipment in the serviced premise. Circuits for lighting and small appliance power outlets (ie. NEMA 1 and NEMA 5) typically use 120 V circuits connected between one of the 120 V hot lines and neutral protected by a single-pole circuit breaker. Higher-demand applications, such as air conditioners, are often powered using 240 V AC circuits connected between the two 120 V AC lines. These 240 V AC loads are protected by two-pole circuit breakers and are either hard-wired or use NEMA 10 or NEMA 14 outlets which are deliberately incompatible with the 120 V AC outlets.

Higher capacity utility networks supplying power to more densely populated centers with larger commercial and industrial areas typically use three-phase transformer banks that reduce the higher three-phase distribution voltage to three 120-degree spaced phases measuring 277 Volts AC from line to neutral and 480 Volts AC from line to line (other wye and delta configurations are also available to provide 240 or 208 V (AC line to line) three-phase power without a reference neutral conductor). The three electrical phases may be delivered in a four wire “Wye” (Y) configuration, providing a neutral and three phases P1, P2 and P3, or three wire “Delta” configuration, delivering three phases P1, P2 and P3, without a neutral. Delta configurations not only require fewer wires (lower conductor costs), but also have a degree of fault tolerance, as a single winding failure at the source will not interrupt power delivery to customers.

Residential, agricultural and smaller commercial/industrial areas in less densely populated areas are often served with single-phase utility distribution systems, providing two-wire single-phase service either 240 Vac or 480 Vac single-phase configurations. 240 Vac single-phase services are typically used to provide 120/240 V service for general household and small commercial/industrial businesses, while 240/480 Vac single-phase services may be used to provide higher capacity single-phase service for higher power applications such as single-phase AC electric motors used with pumps or air handlers, and for other applications, such as electric heating.

Due to the heavy electrical demand of rapid DC charging systems (as much or more than 150 kW), it is common for such chargers to be supplied with three phase, 480 Vac power (Delta or Wye) as is typically delivered from three-phase utility transformers serving commercial/industrial areas. This configuration is generally preferred because three phase power can be rectified into a low-ripple DC voltage suitable for vehicle charging because the three phases provide peak voltage six times per AC cycle rather than only twice as is the case with single phase power. Furthermore, three phase power reduces the current carrying capacity in each supply conductor by providing three wires to share the larger current draw needed to support the power requirements of a rapid DC charging system. Unfortunately, many areas, including rural and agricultural regions, smaller communities, highway rest stops, and lighter commercial/industrial areas, are often supplied using single phase utility distribution systems that provide service in 240 or 480 Vac single-phase configurations. As a result, three-phase 480 Vac electric power is often not readily available. Providing three-phase service can be cost-prohibitive, as it often requires miles of new three-phase distribution infrastructure to provide service at locations where a rapid DC charging system may be desired for charging electric vehicles.

What is therefore needed, is supporting infrastructure enabling the use of rapid DC charging systems with common utility supplies of 480 Vac single-phase power that is readily available in most locations. Furthermore, there is a need to provide such a system with energy storage to enable the system to overcome the challenges inherent with restricted capacity and inconsistent power delivery in those same locations.

U.S. Pat. Nos. 3,931,535, 4,168,459, 4,227,136, 4,406,950, 4,412,170, 4,600,873, 4,663,536, 5,838,085, 5,990,590 and 6,751,842, which are expired, disclose electric motors that may be energized by single-phase power to produce a high horsepower output. A product for agricultural, commercial, and industrial use, currently sold under the trademark “1-TO-3”, uses such a large horsepower single-phase motor mechanically coupled to a three-phase generator to create a separately derived three phase electric output for irrigation equipment, and other commercial and industrial forms of multi-phase equipment. However, this system does not include energy storage or a facility to permit operation of the system in the presence of inconsistent utility power, as is necessary for a reliable, high-capacity electric vehicle charging station.

U.S. Pat. Nos. 6,297,971 and 6,731,525, which are expired, disclose approaches for solid-state phase conversion from a single to multi-phase format, usable for high power applications. While this system provides for phase conversion, it does not provide energy storage or a facility to permit operation of the system in the presence of inconsistent utility power, as is necessary for a reliable, high-capacity electric vehicle charging station.

### SUMMARY OF THE INVENTION

In one aspect, the present invention features an innovation for supplying electrical power from a single-phase utility service to an electric vehicle rapid DC charging station requiring a multi-phase electrical supply. A high-capacity converter connected to a single-phase utility supply converts single-phase input power to a multi-phase power output, which is supplied to an electric vehicle rapid DC charging station.

In some embodiments, a secondary low-capacity converter is used with a transfer switch to deliver a standby power source to the electric vehicle charging station, maintaining communication and status monitoring functionality without engaging the high-capacity converter. A controlled transfer switch delivers higher power rates from the high-capacity converter to the electric vehicle charging station when charging. A controller controls the transfer switch and converters to ensure the efficient delivery of multi-phase power in proportion to the power demands of the rapid DC charging station and in response to the availability and quality of utility power.

In particular embodiments, the system also includes a high-capacity energy storage device and high-capacity charge controller for selectively delivering power from the multi-phase output of high-capacity converter to the high-capacity energy storage device (i.e. charging) or from the high-capacity energy storage device to the multi-phase rapid DC charging station (i.e. discharging). This added capability may be used to increase the overall output available from the high-capacity converter, enabling charge rates that exceed the output capacity of the converter and single-phase utility supply. In more complex embodiments, the high-capacity energy storage may be used to reduce the demand on the utility supply in response to a utility signal (request) for demand curtailment or demand response. The response facilitated by this embodiment decreases the load on the converter by drawing additional power from the high-capacity energy storage device, and thereby reducing the power demand on the utility.

In a further embodiment, the high-capacity energy storage device may be used to provide energy to the charging station during a utility power failure or other power quality event that compromises the availability of the single-phase utility supply. When used as a keep-alive device, the charge controller draws stored energy from a high-capacity storage device to maintain operation of the electric vehicle rapid DC charging system during a utility outage or interruption. In a more detailed embodiment, the controller suspends operation of the electric vehicle charging station and interrupts charging of vehicles by the charging station if stored energy levels are drawn down but maintains the communication and status monitoring functionality of the electric vehicle charging station during the utility power interruption.

In other embodiments, the controller may be coupled to a wireless monitoring and control system that is in communication with a remote computing device for monitoring and control of the multi-phase power supply provided by the invention. This embodiment may co-exist with other embodiments and provide varying levels of monitoring and control for the system.

In further embodiments, the controller is coupled to a vehicle detector and activates the high-capacity converter, and transfer switch if used, to deliver higher power rates from the high-capacity converter when a vehicle is detected at the rapid charging station. In a more detailed embodiment, the controller determines whether the high-capacity converter is ready to provide multi-phase electrical power to the rapid charging station, and in response controls the output and transfer switch required in some embodiments to selectively deliver power from the high-capacity converter and/or energy storage device to the rapid charging station used for electric vehicle charging.

Any of these described embodiments may be enhanced through direct communication with the rapid DC charging station, enhancing the capability of the system controller and various embodiments to respond to the requirements of the rapid charging station.

### BRIEF DESCRIPTION OF THE DRAWINGS

The accompanying drawings, which are incorporated in and constitute a part of this specification, illustrate embodiments of the invention, which together with the detailed descriptions given below, explain various aspects of the invention and its application.

FIG. 1 shows a combined system diagram, including typical components of various embodiments of the invention. FIG. 1a illustrates a base configuration of these components (embodiment 1); FIG. 1b illustrates the base configuration augmented with standby low-capacity phase conversion (embodiment 2); FIG. 1c illustrates the base configuration augmented with standby phase conversion and energy storage (embodiment 3); FIG. 1d illustrates the base configuration augmented with energy storage (embodiment 4); and FIG. 1e illustrates additional combinations of elements (embodiments 4 and 5).

FIG. 2 is a system diagram of two embodiments in which a motor-generator using mechanical conversion provides the phase conversion component 103, the embodiments respectively producing 3 wire Delta output or 4 wire WYE output.

FIG. 3 is a schematic circuit diagram of a solid-state phase converter for use in an alternative embodiment of the present invention.

FIG. 4 is a flow chart illustrating the operation of the controller in FIG. 1 for controlling the system and incorporated low or high-capacity converter(s) to oversee the delivery of charge to electric vehicles in accordance with principles of the present invention in the three basic embodiments of the system, with and without supplemental embodiments described below.

### DETAILED DESCRIPTION

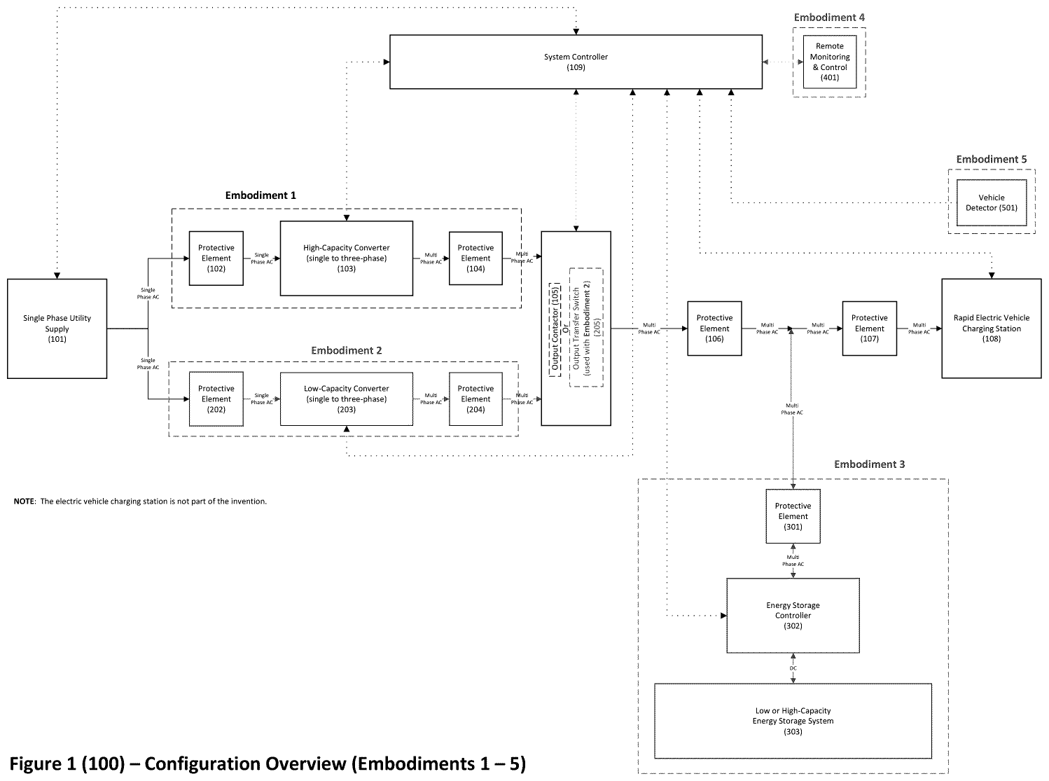

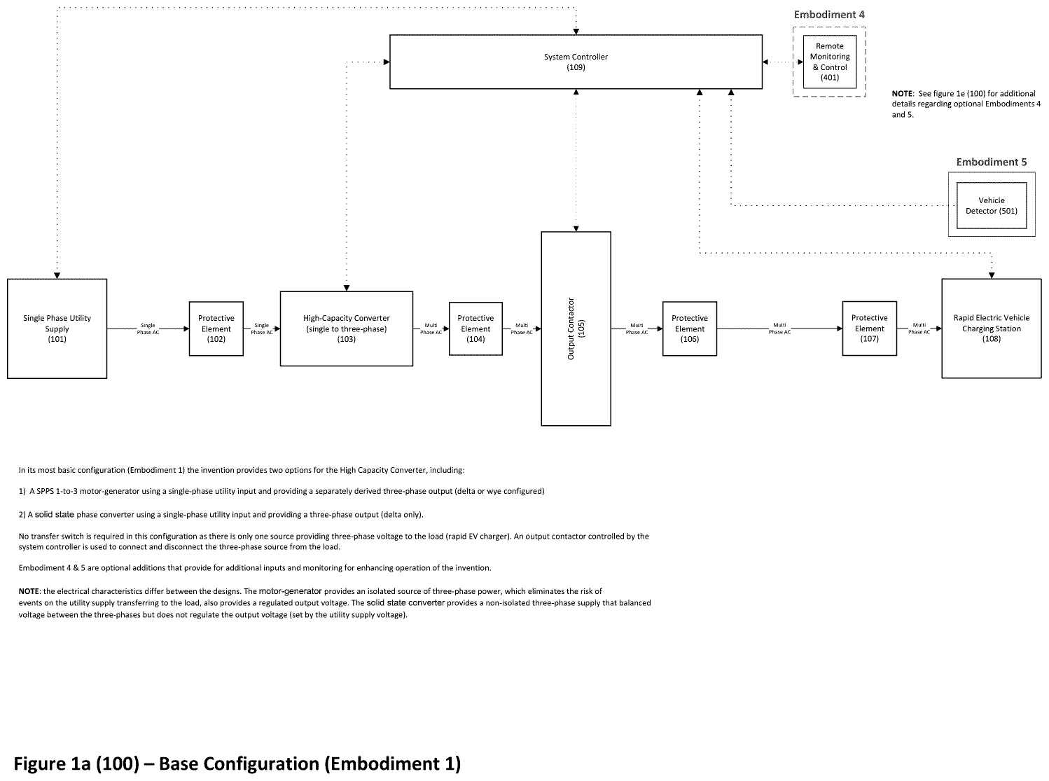

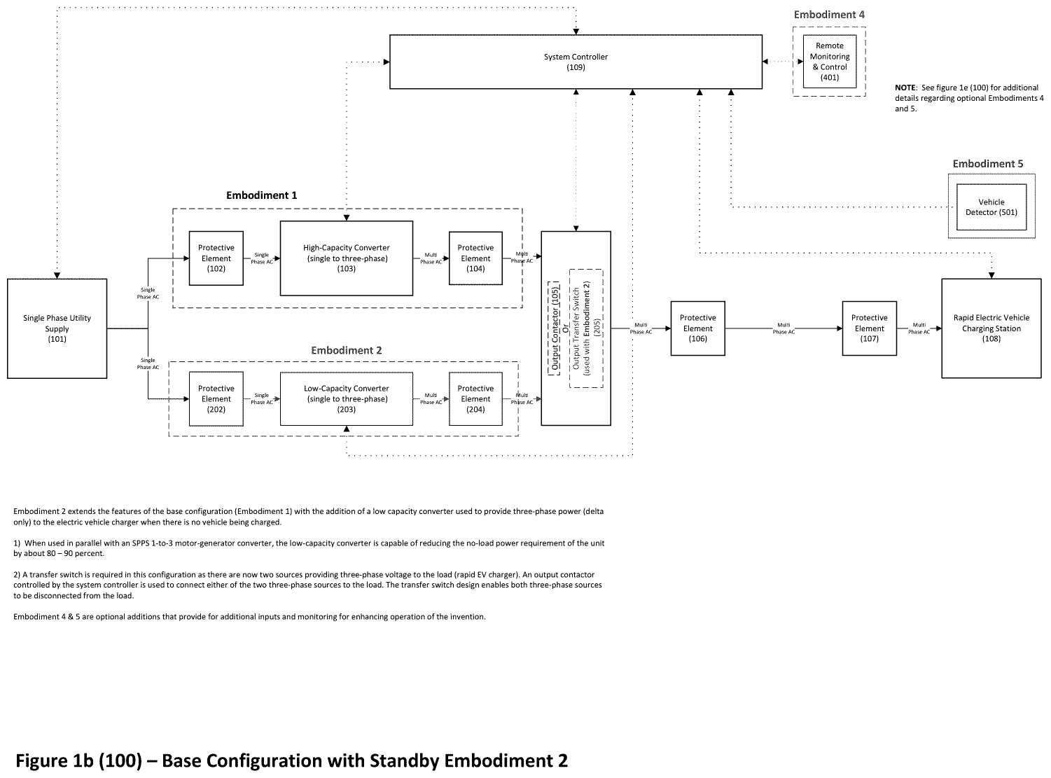

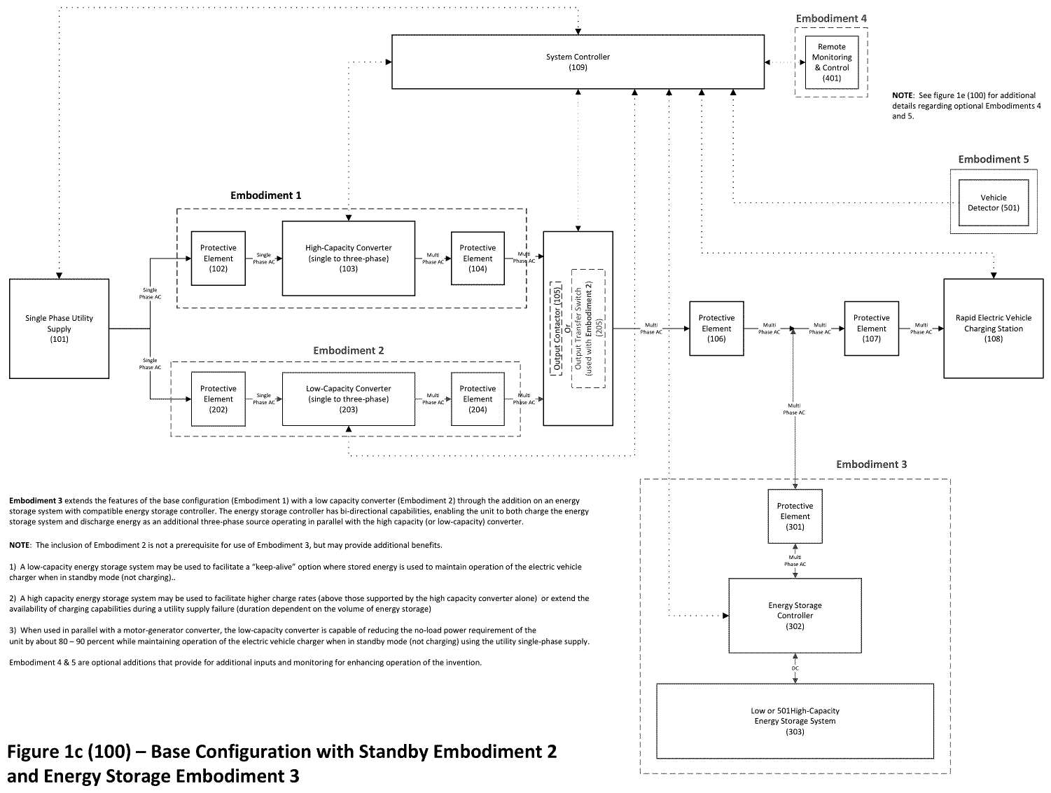

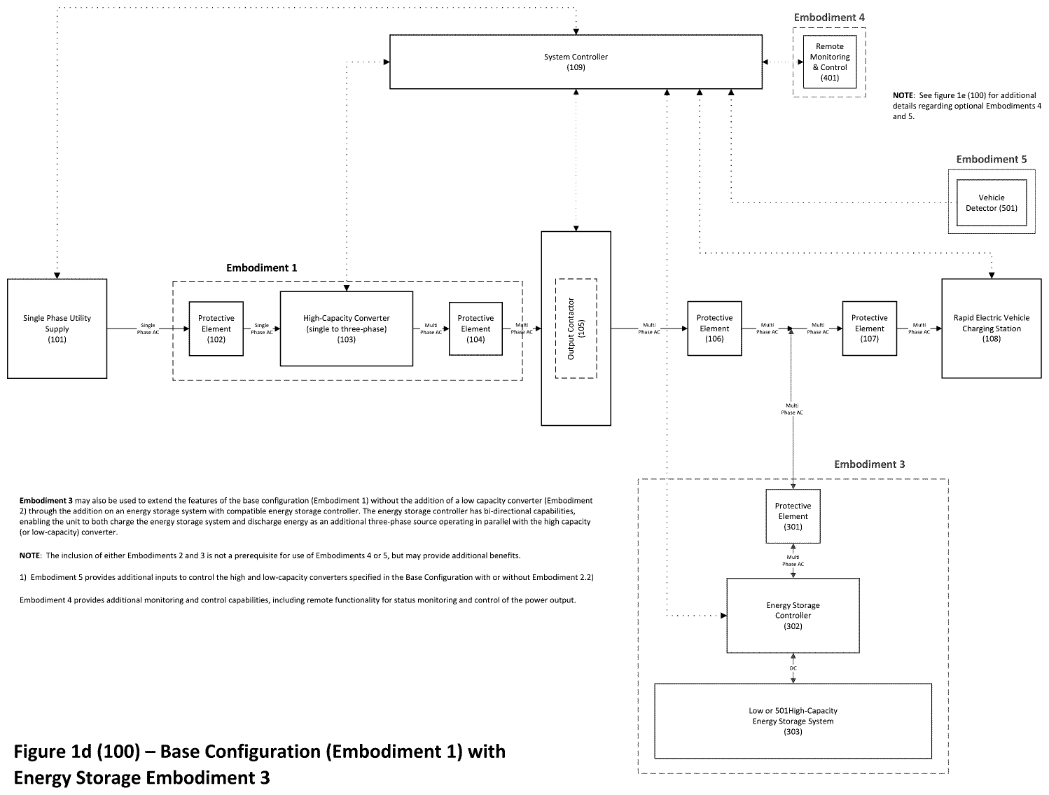

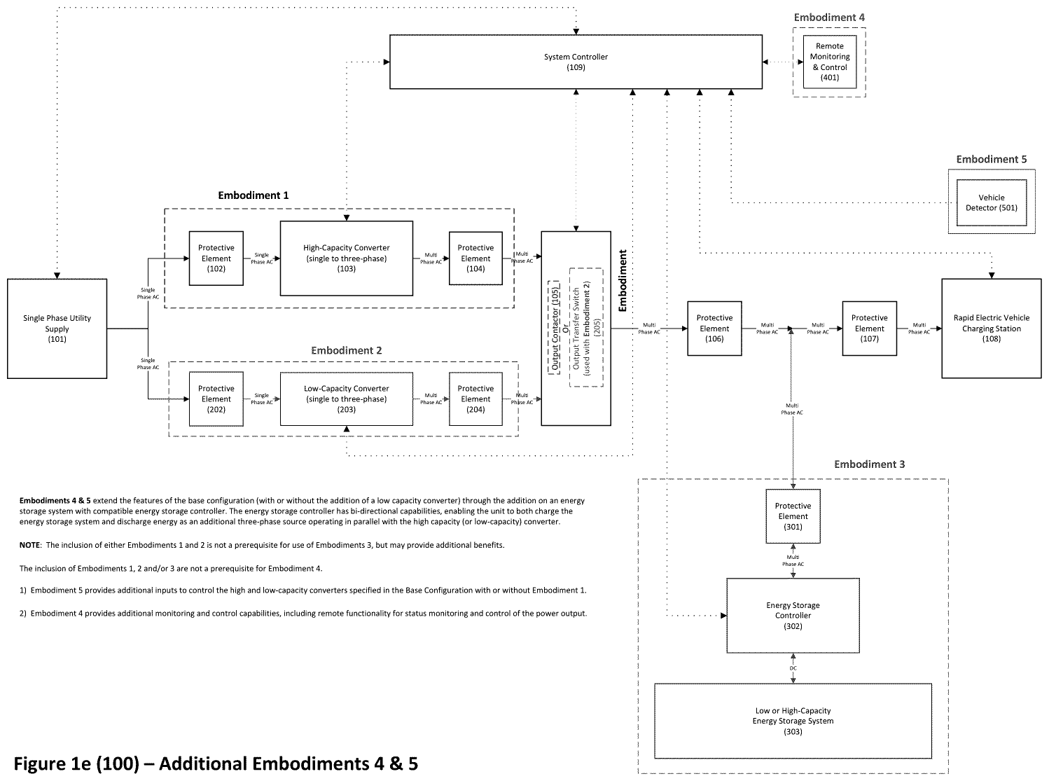

FIG. 1 illustrates the key components of a typical converter configuration with various embodiments of a system 100 for supplying electrical power to an electric vehicle (EV) rapid charging station 108 through conversion of a single-phase utility power supply to a multi-phase output for a rapid charging system. These embodiments utilize utility supplied single phase power, such as 480 Vac single phase power, and produce three phase power, such as 480 Vac three phase output, but other embodiments could produce two phases, four phases, or other multi-phase output power formats for powering an EV charging station with different input power requirements.

Connections to the utility are implemented within a utility supply termination enclosure and fused disconnect box 101. Under the control of a central system controller 109, such as a programmable logic controller (PLC), the circuitry in this fused disconnect box 101 delivers single-phase power, such as 480 Vac single-phase power, via a protective element 102 to a high-capacity converter 103 in Embodiment 1 and, in a first alternate Embodiment 2, via a protective element 202 to an additional low-capacity converter 203.

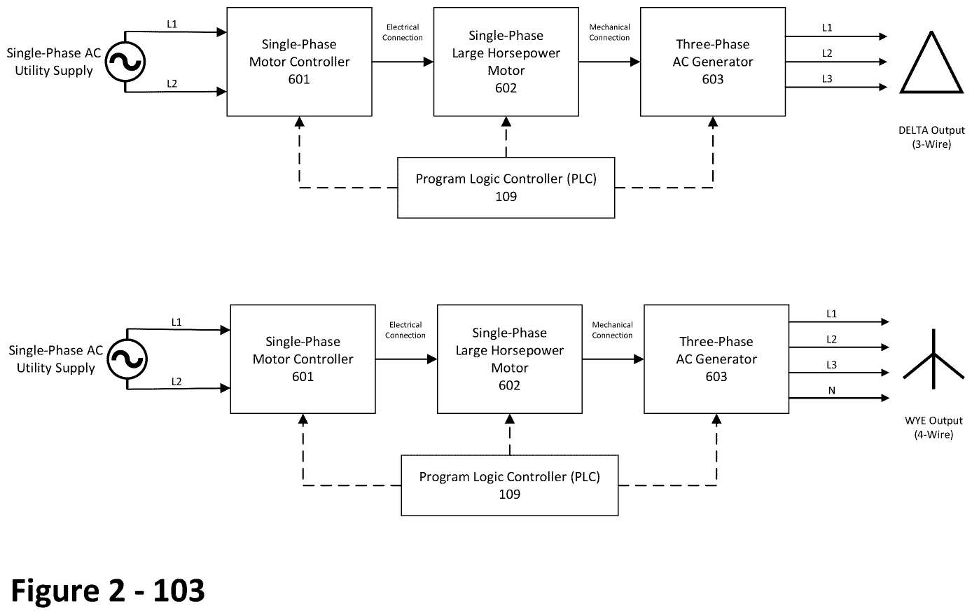

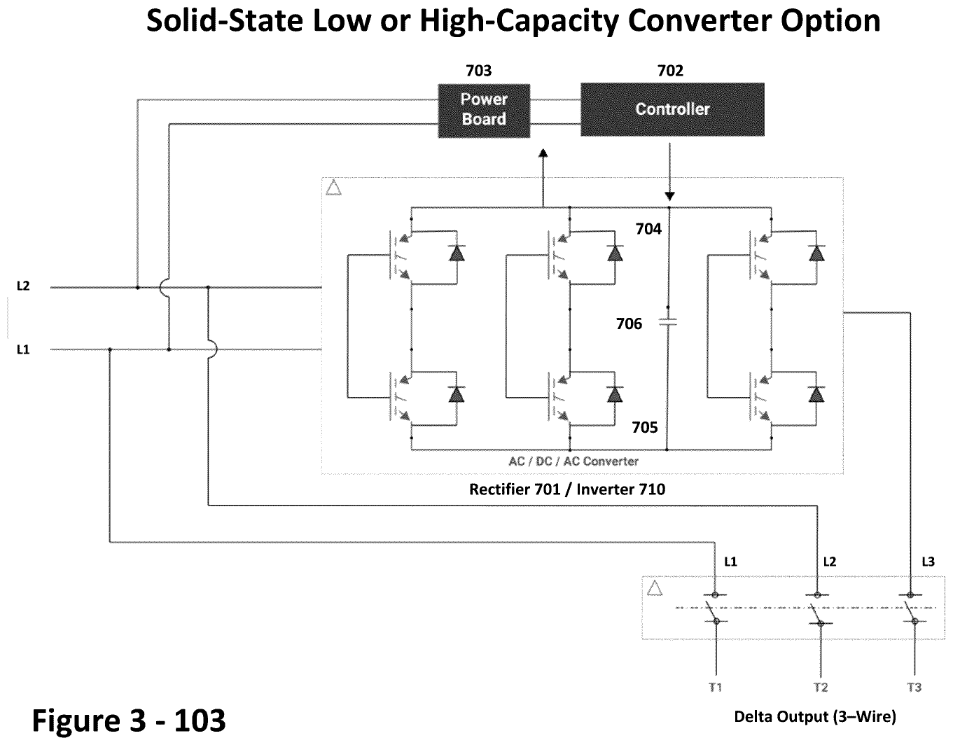

Embodiment 1 uses a high-capacity AC single-phase to multi-phase converter that is selectively controlled by the system controller 109 and produces a high-capacity multi-phase output via a protective element 104 to an output contactor 105 that is compatible for use in delivering multi-phase power via protective element 106 to a rapid charging system 108. Further details on the high-capacity power converter 103 are shown in FIGS. 2 and 3, below.

FIG. 2 illustrates a high-capacity single-phase AC to three-phase AC converter trademarked “1-to-3” sold by Single Phase Power Solutions, LLC, which is described in the Background section of this application and in the patents relating thereto which are incorporated herein by reference.

In the first alternate Embodiment 2, an additional low-capacity converter 203 also converts 480 Vac single-phase power to a 480 Vac three-phase output that is compatible for use with the rapid charging system 108 when said system 108 is in standby mode between vehicle charging sessions.

Various low- and high-capacity single-phase AC to three-phase AC converters are known to persons of skill in the art and are readily available on the open market. FIG. 3 illustrates one suitable low-capacity converter sold by Phase Technologies of 222 Disk Drive, Rapid City, SD 57701, as model no. PT407R-BH3S. A similar high-capacity converter suitable for use in Embodiment 1 is sold by Phase Technologies of 222 Disk Drive, Rapid City, SD 57701, as model no. PT4100R-BH3S. These devices generally utilize the two input phases of the utility supply and synthesize a third phase to combine with the two input phases to create a balanced three phase delta configured output. Additional solid-state devices are described in the patents referenced in the last paragraph of the Background section of this application.

In the first alternate Embodiment 2, the multi-phase output (e.g., three phase 480 V AC) of the high-capacity power converter 103 and low-capacity power converter 203 are delivered to a transfer switch 205, which selectively connects either the high- or low-capacity power converter to a protective element 106 for further connection to a rapid charging station (108). The system controller (109) controls the operating state of the transfer switch, to transfer power from the utility as converted by the high-capacity converter, or transfer power from the utility as converted by the low-capacity converter 202, to power the rapid charging station 108 and related devices, as necessary to meet the input power requirements of the charging station.

A second alternative Embodiment 3 includes an optional energy storage system including an energy storage controller 302 and a low or high-capacity energy storage system 303 connected via a protective element 301. The energy storage system may be used to store energy during periods of low use (such as overnight) for later delivery to the rapid DC charging system. The stored energy may be used to satisfy the demand for electric vehicle charging power during periods of peak load (such as mid-day) or when utility power has been interrupted (functioning as an uninterruptible power supply system) or is of low quality (e.g., a brown out). If these components are in use, the system controller 109 detects the status of the converter output and controls the energy storage controller to charge the energy storage system whenever excess output from the converter is available and drawing energy from the energy storage system via the energy storage controller when required to maintain available power at the EV rapid charging station under conditions of insufficient or constrained converter output.

In a third alternate Embodiment 4, the system controller may be connected to a remote monitoring/control system 401 e.g., a system using a cellular modem for Internet access to provide remote control and monitoring of the system 100 through the system controller 109.

In addition to connections to the circuits and subsystems described above, in a fourth alternate Embodiment 5, the system controller may also be connected to a vehicle detector 501, such as a ground loop-based detector, enabling detection of an electric vehicle at the EV charging station seeking to be charged.

Referring to FIG. 2, a high-capacity converter 103 in accordance with a first Embodiment 1, utilizes a large horsepower single-phase electric motor mechanically coupled to a three-phase generator to create three phase output power under the control of the system controller (109). Specifically, a single-phase electric motor controller 601 is energized by the single-phase utility power supply producing the necessary service capacity to operate a large horsepower single phase motor 602, such as the BELLE large horsepower, single-phase motor sold by Single-Phase Power Solutions, LLC. The output shaft of motor 602 is directly coupled to the input shaft driving the rotor of a three-phase generator 603, which produces a separately derived source of three-phase AC power for supply to the rapid DC charging station. The multi-phase output may be configured in a 3-wire delta or 4-wire configuration depending on the input power requirements of the charging station.

In one particular embodiment, the motor 602 is a 100 HP single phase motor operating on 480 Vac single phase power.

Referring to FIG. 3, a second embodiment of a high-capacity phase converter 103 embodying features of the present invention uses solid state circuitry to develop three-phase 480 Vac power from a 480 Vac single-phase supply. In one version of this embodiment, the two input legs of the single-phase utility supply pass directly through the converter to provide two phases of the three-phase output. The third leg is synthesized from DC power produced by rectifier 701. Under the control of a digital controller 702 powered by its own power supply 703, rectifier 701 develops a DC voltage on terminals 704, 705 of storage capacitor C 706. The power on terminals 704, 705 is used to synthesize a third phase using an inverter 710.

In the illustrated embodiment the voltage between first and second input terminals L1 and L2 may be 480 V AC, and a third leg may be synthesized to provide three-phase L-L power at 480 V AC. Other voltages are suitable.

Rectifier 701 may utilize a passive diode bridge, or may utilize a controlled rectification bridge using, e.g., silicon-controlled rectifiers (SCRs) instead of diodes. Digital controller 703 controls rectifier 701 via control signals which enable operation of the rectifier and manage operational timing of the rectifier. Power for the digital controller 703 is provided by a power supply 702 which derives its power from L1 and L2.

Rectified energy from lines L1 and L2 is stored in energy storage capacitor C 706 which supplies inverter 710. Inverter 710 creates a synthesized third phase of approximately 415 V AC by the operation of a parallel connected set of insulated-gate bipolar transistors (IGBTs) which are enabled in a timed and controlled sequence by digital controller 702.

As noted above, in this particular system, the two single phase leads to the load come directly from the power line. Power to generate the voltage for the third lead flows into the digital phase converter through semiconductor switches to deliver energy to capacitor C. The switches on the input can control the waveform of the input current to minimize harmonic distortion on the power grid. The capacitor C 706 is connected to a second set of semiconductor switches which feed a second inductor and a filter capacitor to smooth out the high-frequency pulses created by the switches.

The digital controller 702 for this particular embodiment of the system is a small micro-controller, specifically a digital signal processor (DSP) which can measure voltages and deliver pulses into the switches, in addition to performing high-speed calculations. The output voltage is made equal in magnitude to the input voltage to an accuracy that is primarily determined by the measurement accuracy of the DSP.

Further details on the operation of this circuit and alternative circuits can be found in the aforementioned US Patents incorporated herein. Numerous other solid-state circuits using different components and implementing different theories of operation are also suitable, including circuits which synthesize two or all three output power phases, or synthesize additional phases for a 4-phase, 5-phase or greater number of phase outputs.

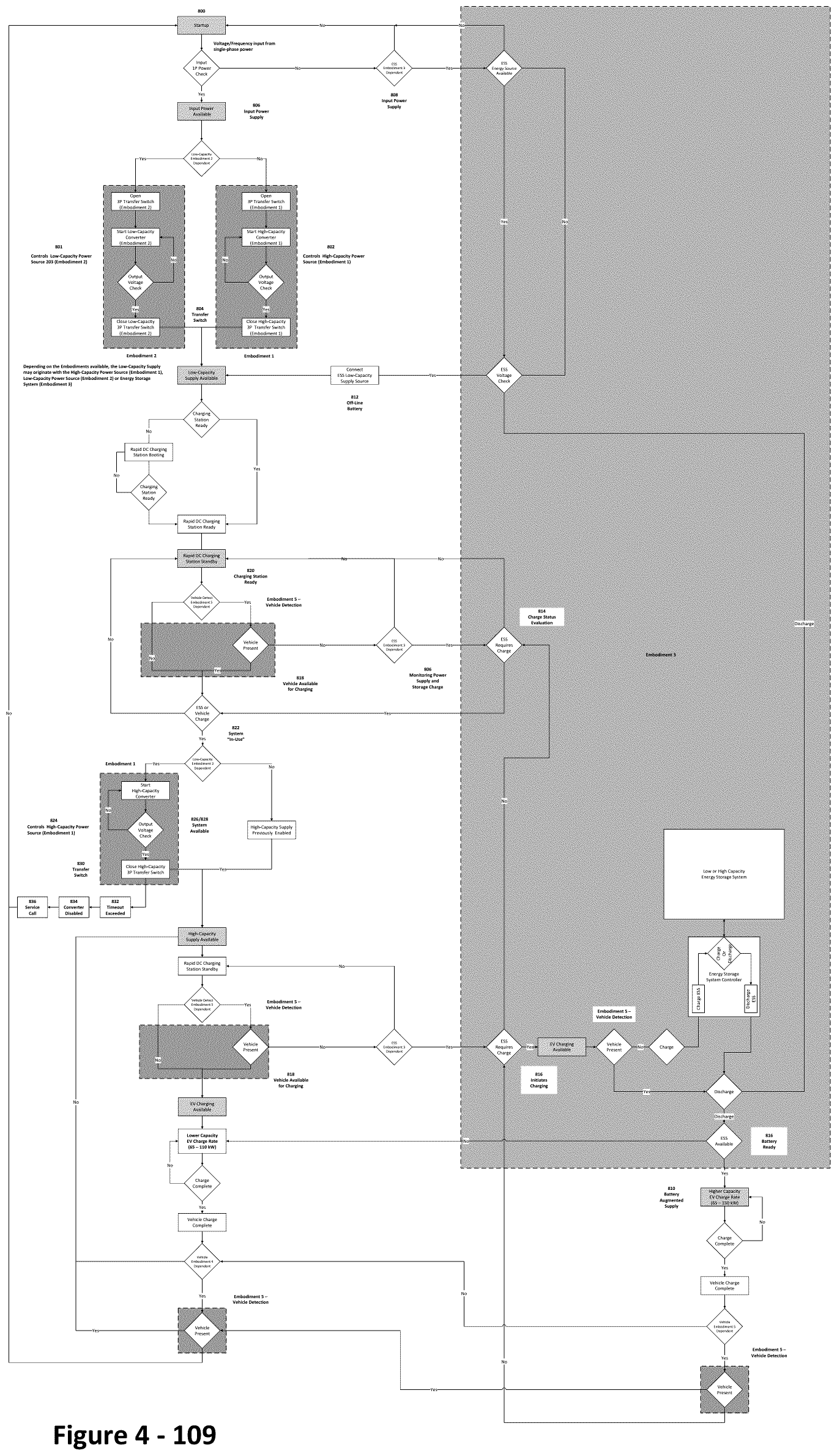

Referring now to FIG. 4, the operation of the controller 109 of FIG. 1 can be elaborated. At startup 800, in embodiments using a low-capacity converter 203 and transfer switch 205, the system initially operates the low-capacity converter 801, and thus deactivates 802, the high-capacity converter 103 (FIG. 1) and connects 804 the transfer switch 205 to the low-capacity power converter 802, so that the charging station operates in a low power consumption (standby) mode.

While the power station is operating, the controller evaluates 806 to determine whether the input power is currently acceptable, or alternatively if there has been a power failure or “brown out”. In the event there is unacceptable input power, the controller enters an islanded mode by proceeding to step 808, facilitated by Embodiment 3 including an energy storage system 303 (FIG. 1). In this mode, electric vehicles may be charged by the station even during periods of unacceptable input power so long as there is sufficient charge in the energy storage system (e.g., battery) 303. Accordingly, in such embodiments, in step 808 the charge status of the energy storage is evaluated. If there is sufficient charge, then the status of the station is “battery-augmented” 810, and operation continues. If, however, the battery has discharged, or there is insufficient charge in the battery to continue operation, then the status of the station is “offline” 812 and will remain so until the input power is once again acceptable.

If there is acceptable input power, then the station will ensure that its energy storage system is charged (if used), while it waits for an electric vehicle. Thus, if an energy storage system 303 is included, in step 814 the controller determines if the energy storage system 303 is charged. If not, then in step 816, the status of the station is “ready/charging”, and the controller continues to step 824 in which the high-capacity power converter is activated (if necessary) to supply high-capacity power to charge the energy storage system.

If, in step 814, the energy storage system is charged, or there is no energy storage system in use, then the controller will evaluate 818 (e.g., in the alternate embodiment noted above, using the vehicle detector 501) whether there is an electric vehicle at the station seeking to be charged. If there is no vehicle at the station, then the station is considered “ready” 820, and processing returns to step 806 to continue monitoring the station's power supply and optionally its energy storage charge, and optionally operate on a low-capacity phase converter, while waiting for an electric vehicle.

If in step 818, there is an electric vehicle at the station, then the status of the station is “in use” 822, and the controller proceeds to step 824 in which the high-capacity power converter is activated (and the low-capacity power converter deactivated, if needed), to supply high-capacity power to charge the EV. A similar process is followed if step 806 determines in conjunction with step 814 that the energy storage battery requires charging.

After the high-capacity power converter is activated in step 824, the controller evaluates 826 the status of the high-capacity converter to determine whether it is ready for use. The high-capacity power converter may have a substantial start-up time, necessary to spool up the rotation of the mechanical conversion system or to charge the various capacitors and other energy storage components of a solid-state system if that system has been deactivated. During this wait, the controller tests in step 828 if too much time has elapsed without the high-capacity power converter becoming available. If the wait has not timed out, the controller simply re-tests in step 826 for the status of the high-capacity converter. When the high-capacity power converter becomes available, in step 830 the controller (if necessary) activates the transfer switch 205 to connect the high-capacity power converter to the charging station, after which the station can be used to charge an EV, and the controller returns to step 806 and the following steps in which it monitors the status of the EV charging and the station.

As can be seen, after commencement of EV charging and/or high-capacity battery charging, the controller will perform a loop of steps in which it will continually monitor for acceptable input power, the charge level of the storage system 303 (if used), and the presence of an EV, and will keep the high-capacity power converter operating until it is no longer needed for vehicle charging, at which point the controller will proceed from one of steps 814 or 818 to change the status of the station to “ready/charging” or “ready”, as appropriate, and then ultimately return to step 800 and deactivate the high-capacity power converter if a low-capacity power converter is available.

As noted above, there is a timeout process that occurs when the high-capacity power converter is activated in step 824. This timeout process involves steps 826 and 830. If, in step 830, the maximum acceptable wait period has been exceeded, then there is a problem in the high-capacity power converter and the status of the station is “failure” 832. In this case, the high-capacity power converter is disabled 834 and a service call is placed 836.

It will be appreciated that the charge station described herein, operated as explained here, provides an elegant solution to the challenges of rural electric vehicle charging, which hinder the adoption of electric vehicles outside of urban areas, and thus provides a way to dramatically increase that adoption and reduce the use of hydrocarbon fuels for transportation in less densely populated locales or for purposes requiring extended travel distances.

Those of ordinary skill in the art will appreciate that there may be various manners of providing vehicle charging from single phase electrical power. For instance, alternative electrical or mechanical systems than those disclosed herein may be implemented to transfer energy from a single phase to a multi-phase format for delivery to a DC fast charger. Furthermore, energy storage for a DC fast charger may be incorporated within the charger rather than be provided separately as disclosed herein, in which case the controller disclosed herein may interact with the DC fast charger to determine the necessity for delivering high capacity three phase power to allow for energy storage. Moreover, the multi-phase format delivered to the DC fast charger may utilize two phases spaced at 180 degrees, four phases spaced at 90 degrees or a higher number of phases, or phases spaced unequally, without variance from the inventive principles described herein. Various other modifications may be made to the illustrated embodiments without departing from the spirit and scope of the invention. Therefore, the invention lies in the claims hereinafter appended.

What is claimed is:

1. A power conversion system for supplying multi-phase electrical power to an electric vehicle rapid charging station, comprising:
a. a utility service connection providing single-phase electrical power;
b. a high-capacity converter coupled to said utility power source for converting single-phase utility power to multi-phase power, and
c. a controller coupled to said rapid charging station and high-capacity converter controlling said high-capacity converter for delivery of power required by rapid charging stations for electric vehicle charging.

2. The system of claim 1 further comprising a wireless monitoring and control system coupled to the controller, in communication with a remote computing device for monitoring and control of power supplied to the electric vehicle charging system.

3. The system of claim 1 wherein said controller suspends charging of vehicles by said rapid charging station in the event of insufficient utility power but maintains capabilities for remote monitoring and control.

4. The system of claim 1 further comprising a vehicle detector coupled to the controller,
wherein said controller is responsive to said vehicle detector to activate said high-capacity converter to deliver power from the high-capacity converter when a vehicle is detected at said rapid charging station.

5. The system of claim 1 further comprising
a. a low-capacity converter coupled to said utility power input for converting single-phase utility power to multi-phase power, the low-capacity converter having a lower current capacity than the high-capacity converter,
b. a transfer switch for selectively coupling the high-capacity converter or low-capacity converter to the rapid charging station, and wherein
c. the controller coupled to said low-capacity converter and transfer switch and controlling said low capacity converter and transfer switch to deliver power to the rapid charging station from the low capacity converter when the power demands of the rapid charging station can be met by the current capacity of the low capacity converter, and deliver power from the high capacity converter when the power demands of the rapid charging station exceed the current capacity of said low capacity converter.

6. The system of claim 5
further comprising a keep-alive energy storage device and keep-alive charge controller coupled to said utility power input and to said low-capacity converter, and
wherein said keep-alive charge controller stores energy received from said utility power input into said keep-alive energy storage device and draws energy from said keep-alive charge controller when necessary to maintain operation of said low-capacity converter.

7. The system of claim 1 further comprising
a. an energy storage device and corresponding bi-directional charge controller,
b. the charge controller coupled to said energy storage device and the output of said high-capacity converter, and wherein
c. the controller controls said high-capacity converter to add stored energy to the storage device from the output of the converter and augmenting the output of said high-capacity converter by drawing on stored energy in the energy storage device based on the sufficiency of the utility power source, high-capacity converter, and the accompanying load demand created by the rapid DC charging station.

8. The system of claim 7 wherein said controller suspends operation of said high-capacity converter in the event of insufficient utility power and insufficient energy in said high-capacity energy storage device.

9. The system of claim 7
further comprising a vehicle detector coupled to the controller,
wherein said controller is responsive to said vehicle detector to activate said high-capacity converter and/or said high-capacity energy storage device, to deliver power to the rapid DC charge station when a vehicle is detected at said rapid charging station.

10. The system of claim 1 further comprising a high-capacity energy storage device, and wherein said controller determines whether said high-capacity converter is ready to provide multi-phase electrical power to said rapid charging station, and in response selectively delivers power from the said high-capacity converter and/or said high-capacity energy storage device to the rapid DC charging station to be used for vehicle charging.

11. A power conversion system for supplying multi-phase electrical power to an electric vehicle rapid charging station, comprising:
a. a utility service connection providing single-phase electrical power;
b. a high-capacity converter coupled to said utility power source for converting single-phase utility power to multi-phase power,
c. a low-capacity converter coupled to said utility power input for converting single-phase utility power to multi-phase power, the low-capacity converter having a lower current capacity than the high-capacity converter,
d. a transfer switch for selectively coupling the high-capacity converter or low-capacity converter to the rapid charging station, and wherein
e. the controller coupled to said rapid charging station, high capacity converter, low-capacity converter and transfer switch and controlling said high capacity converter and low capacity converter and transfer switch to deliver power to the rapid charging station from the low capacity converter when the power demands of the rapid charging station can be met by the current capacity of the low capacity converter, and deliver power from the high capacity converter when the power demands of the rapid charging station exceed the current capacity of said low capacity converter.

12. A power conversion system for supplying multi-phase electrical power to an electric vehicle rapid charging station, comprising:
a. a utility service connection providing single-phase electrical power;
b. a high-capacity converter coupled to said utility power source for converting single-phase utility power to multi-phase power, and
c. a controller coupled to said rapid charging station and high-capacity converter controlling said high-capacity converter for delivery of power required by rapid charging stations for electric vehicle charging.
d. an energy storage device and corresponding bi-directional charge controller,
e. the charge controller coupled to said energy storage device and the output of said high-capacity converter, and wherein
f. the controller controls said high-capacity converter to add stored energy to the storage device from the output of the converter and augmenting the output of said high-capacity converter by drawing on stored energy in the energy storage device based on the sufficiency of the utility power source, high-capacity converter, and the accompanying load demand created by the rapid DC charging station.

13. A power conversion system for supplying multi-phase electrical power to an electric vehicle rapid charging station, comprising:
a. a utility service connection providing single-phase electrical power;
b. a solid state, high-capacity converter coupled to said utility power source for converting single-phase utility power to multi-phase power, and
c. a controller coupled to said rapid charging station and high-capacity converter controlling said high-capacity converter for delivery of power required by rapid charging stations for electric vehicle charging, wherein said controller suspends charging of vehicles by said rapid charging station in the event of insufficient utility power but maintains capabilities for remote monitoring and control.
